(19) United States
(12) Patent Application Publication
(10) Pub. No.: US 2016/0134684 A1
(43) Pub. Date: May 12, 2016

(54) SYSTEM AND METHOD FOR UPLOADING, SHOWCASING AND SELLING NEWS FOOTAGE

(71) Applicant: T-DATA SYSTEMS (S) PTE LTD, Singapore (SG)

(72) Inventors: Joon Yong Wayne TAN, Singapore (SG); Teng Pin POO, Singapore (SG)

(73) Assignee: T-DATA SYSTEMS (S) PTE LTD, Singapore (SG)

(21) Appl. No.: 14/898,352

(22) PCT Filed: Jun. 13, 2014
(86) PCT No.: PCT/SG2014/000280

§ 371 Date: Dec. 14, 2015

Related U.S. Application Data
(60) Provisional application No. 61/835,217, filed on Jun. 14, 2013.

(51) Int. Cl. H04L 29/08; G06Q 20/12

(52) U.S. Cl. CPC H04L 67/06; G06Q 20/123

(57) ABSTRACT

A system for uploading, showcasing and selling news footage on the internet, comprising an upload control manager configured to receive an upload request from a wireless module on a recording device, the upload request including an identification number and a plurality of FTP servers, the upload control manager configured to select at least one FTP server from the plurality of FTP servers to service the upload request and receive the recorded news footage from the wireless module. The system further comprises a database server configured to receive the news footage from the FTP servers and for showcasing the footage on the internet to allow customers to preview and purchase the footage, wherein the at least one FTP server to service the upload request is selected based upon the upload control manager determining the least loaded FTP servers amongst the plurality of servers and user privileges tagged to the identification number.

### FIELD OF THE INVENTION

The present invention relates to a system and method for uploading, showcasing and selling news footage.

### BACKGROUND

News programs routinely broadcast news footage which has been taken by by-standers near the scene of an incident or event. This footage is very important to the news story as it depicts the actual incident or event when it occurred. However, there is currently no platform or system in the art for which such footage could be uploaded, sold and broadcast in an effective manner.

In providing such a platform, this would allow freelance cameraman or photographers to conveniently upload their recorded news footage, and be monetary compensated by television networks for the rights to broadcast their news footage, which would in turn encourage and stimulate this “freelance” market.

The invention as described herein therefore seeks to create a convenient and cost-effective platform for such footage to be uploaded, sold and broadcasted, and also to decrease the time-to-market for the footage.

In anticipating a large number of upload requests of news footage in such a news footage trading platform, there is also a need a provide load balancing and task prioritization among FTP (File Transfer Protocol) servers. Traditionally, FTP load balancers handle uncontrolled external client service requests and forward them to one of the backend servers. The FTP load balancers usually have to translate the IP address in the incoming request and outgoing answer flow so that each backend server may be unaware of the task distribution by the load balancer. This task typically requires a high-speed machine to ensure optimal performance. Traditionally, multiple users may send a request any time. The FTP client will use an account (with or without password) to login to the FTP server to perform the uploading/downloading of files. The FTP server has to handle the load (or all requests) in time. A typical FTP server running on a computer can handle around 100-200 concurrent uploading requests. Any additional requests will be delayed. So without any load balancing, a server with numerous requests will cause users to experience slow and poor uploading speeds.

Currently, such load balancing is only achieved using expensive equipment like Cisco IOS load balancer, f5 BIG-IP, KEMP LoadMaster, etc. The reason being that the user has a pre-assigned FTP server IP address which cannot be changed. Hence, the user can only use that particular FTP server even if it is heavily loaded with other uploading operations.

Given the above, it is desirable and another object of the invention to control the uploading of data to selected servers so as to distribute the uploading load to the various servers more evenly.

### SUMMARY OF THE INVENTION

In a preferred embodiment of the invention, the news footage trading platform enables (1) cameramen to wirelessly upload their video files and pictures to a cloud-based storage location, and (2) provide news broadcasters a convenient online platform with which to purchase and download the video files and pictures.

According to a first aspect of the invention, a system for uploading, showcasing and selling news footage on the internet is described, the system comprising an upload control manager configured to receive an upload request from a wireless module on a recording device, the upload request including an identification number; and a plurality of FTP servers, the upload control manager configured to select at least one FTP server from the plurality of FTP servers to service the upload request and receive news footage from the wireless module, the news footage recorded by the recording device. The system further comprises a database server configured to receive the news footage from the plurality of FTP servers and for showcasing the news footage on the internet to allow customers to preview and purchase the news footage; and wherein the upload control manager selects the at least one FTP server based upon the upload control manager determining the least loaded FTP servers amongst the plurality of FTP servers and based upon user privileges tagged to the identification number.

Preferably, the user privileges tagged to the identification number include any one of: selecting a dedicated FTP server or selecting a FTP server that satisfies a server-user ratio threshold.

Preferably, the news footage is a plurality of video files and the upload control manager is configured to receive metadata of the plurality of video files from the wireless module, and send to a mobile application a video file list, the video file list providing selection on the sequence in which the plurality of video files will be uploaded to the at least one selected FTP server.

Preferably, the system further comprises a process control server and a plurality of processing servers for processing the news footage.

Preferably, the wireless module is built-in to the recording device or is part of a removable wireless memory card attached to the recording device.

According to a second aspect of the invention, a method for uploading, showcasing and selling news footage on the internet is described, the method comprising the steps of receiving on a upload control manager, an upload request from a wireless module on a recording device, the upload request including an identification number; and selecting using the upload control manager, at least one FTP server from a plurality of FTP servers to service the upload request, the selecting based upon the upload control manager determining the least loaded FTP servers amongst the plurality of FTP servers and based upon user privileges tagged to the identification number. The method further comprises the steps of receiving on the at least one selected FTP server, news footage from the wireless module, the news footage recorded by the recording device; and transferring the news footage from the at least one selected FTP server to a database server, to showcase the news footage on the internet to allow customers to preview and purchase the news footage.

Preferably, the user privileges tagged to the identification number include any one of: selecting a dedicated FTP server or selecting a FTP server that satisfies a server-user ratio threshold.

Preferably, the news footage is a plurality of video files, and the method further comprising the steps of receiving on the upload control manager, metadata of the plurality of video files from the wireless module; and sending from the upload control manager, a video file list to a mobile application, the video file list providing selection on the sequence in which the plurality of video files will be uploaded to the at least one selected FTP server.

Preferably, the method further comprises the step of processing the news footage with a process control server and a plurality of processing servers.

Preferably, the wireless module is built-in to the recording device or is part of a removable wireless memory card attached to the recording device.

The invention will now be described in detail with reference to the accompanying drawings.

### BRIEF DESCRIPTION OF THE DRAWINGS

The accompanying figures illustrate disclosed embodiment(s) and serve to explain principles of the disclosed embodiment(s). It is to be understood, however, that these drawings are presented for purposes of illustration only, and not for defining limits of the application.

FIG. 1 shows a shows news footage trading platform or system in accordance with a preferred embodiment of the invention;

FIG. 2 shows the steps of pre-configuring wireless memory card prior to use with news footage trading platform;

FIG. 3 shows a screen capture of the web server interface of wireless memory card;

FIG. 4 shows the steps taken in load balancing;

FIG. 5 is a flowchart which shows the method of uploading a video file from a wireless memory card onto database server in accordance with a preferred embodiment of the invention;

FIG. 6 is a flowchart which shows the method of uploading a video file from wireless memory card onto database server with the step of allowing cameramen to set the order or sequence of the uploading of video files to the FTP servers;

FIG. 7 is a flowchart which shows the method of uploading a video file from wireless memory card onto database server with the step of assigning FTP servers that meets a server-user ratio threshold to premium users.

Exemplary, non-limiting embodiments of the present application will now be described with references to the above-mentioned figures.

### DETAILED DESCRIPTION

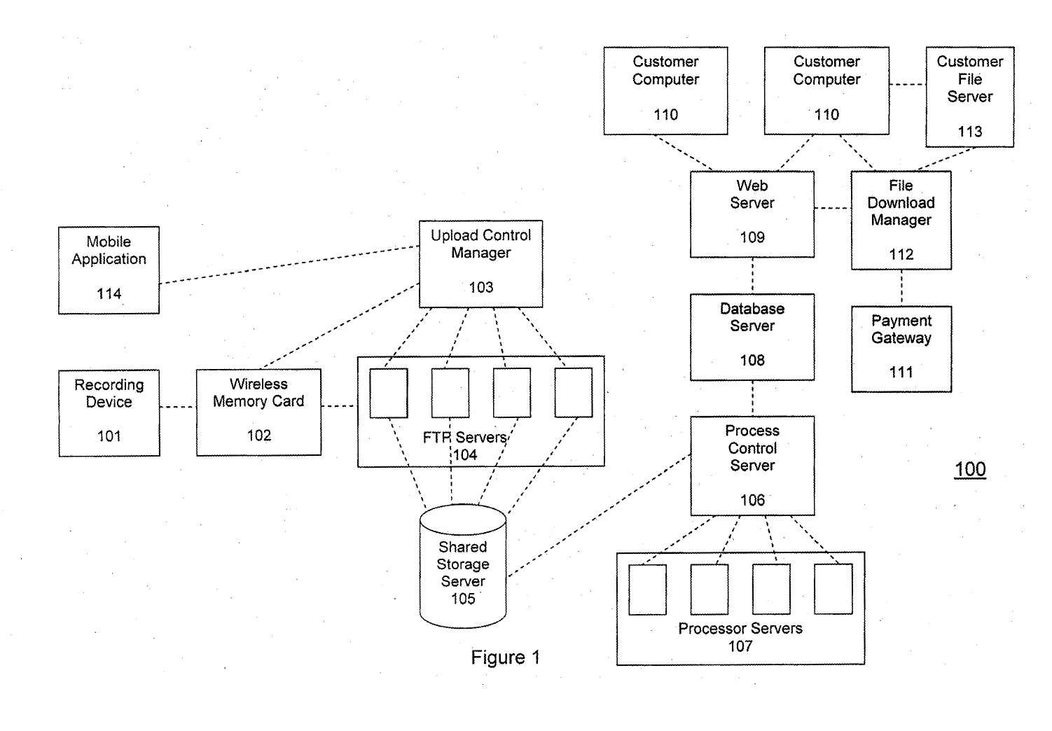

FIG. 1 shows news footage trading platform 100 in accordance with a preferred embodiment of the invention. Recording device 101 is operated by a cameraman/independent journalist/user. Cameraman, independent journalist and user are used interchangeably in this specification. They are the people who record the news footage with their recording devices 101, and upload the news footage to the system. They are independent from the operator of the system and are users of the system. The system also segregates them by identifying some as “premium users”. Premium users are cameramen who pay a premium for special privileges. Normal users are cameramen who choose to not pay a premium and are therefore not entitled to the special privileges. These special privileges will be discussed later in the specifications.

Recording device 101 comprises removable wireless memory card 102. Wireless memory card 102 is preconfigured to contain the cameraman's details such as user account ID and password. Wireless memory card 102 allows the news footage or video file recorded by recording device 101 to be wirelessly transmitted to upload control manager 103. Upload control manager 103 can be a server.

Prior to the wireless transmission of the video file from wireless memory card 102 to upload control manager 103, wireless memory card 102 contacts upload control manager 103 by automatically logging into upload control manager 103 with a user account ID and password.

Upload control manager 103 sees this request from wireless memory card 102 and selects and assigns FTP (File Transfer Protocol) server 104 to wireless memory card 102. Preferably, upload control manager 103 selects an FTP Server 104 from a plurality of FTP servers 104, which is under-utilized and has a lesser workload for load balancing. Specific details on load balancing will be explained later. Upload control manager 103 then sends the IP (Internet Protocol) address of FTP server 104 to wireless memory card 102. Wireless memory card 102 then uses the IP address of assigned FTP server 104, user account ID and password to upload the video files to FTP server 104.

Wireless memory card 102 may also comprise firmware which can generate and upload a meta-data file associated with the uploaded video file. The meta-data would contain information about the video file, for example, length of the video, recording bit-rate, and descriptions of the video. The meta-data could also include a unique ID of wireless memory card 102. As this unique ID is tagged to a particular cameraman, the associated meta-data file can be used to uniquely identify the cameraman who uploaded the video file. The video file and the associated meta-data file could be handled as a pair within the system.

The cameraman may also have a mobile application 114 on a mobile device to connect to upload control manager 103, and set price and sale models for the uploaded video files. For example, cameraman can use mobile application 114 to set permissions to allow auctioning of the video file, set bidding periods, or request that a watermark be added to the video file during processing.

After the video file has been uploaded to FTP server 104, FTP server 104 moves the video file to shared storage server 105, under the control of process control server 106. Unique filenames may be automatically assigned to each video file to avoid repetition.

The video files stored in shared storage server 105 are then further processed by process control server 106 and processing servers 107, for example by converting the video files into different formats and video quality. If the video file is of poor quality and resolution, the quality and resolution would be upgraded to such that the processed video file would have acceptable quality and resolution. Acceptable quality and resolution is a standard which news broadcasters would deem to be sufficient for the processed video file to be played on television, as ultimately, this processed video file would be the product that would be purchased by the news broadcasters and reproduced on television or the like. As one cannot expect all cameramen to have the state of the art recording devices 101, this processing step is vital to ensure that news broadcasters receive a video file of acceptable quality. However, if the video file is of too high quality and resolution which results in it being a very large file, it may be processed such that the size of the video file becomes more “manageable”. This is because as the processed video file would be kept in storage, it is important to optimize the storage space by keeping the size of the video file “manageable”, but at no cost to its reproducibility. Process control server 106 controls the processing of the video files and may assign different processing servers 107 with different computing resources to give processing priority to “premium users”. This creates a better resource to user ratio for “premium users”.

The processed video files are stored in database server 108, with each processed video file tagged under the cameraman's account. Web server 109 retrieves the processed video files in database server 108 and presents the processed video files in the form of video clips for customers to preview and purchase. Customers and news broadcasters are used interchangeably here. They are the news stations, global media players, stock photo agencies, for example, CNN, Channel News Asia, Bloomberg, Getty Images, etc.

After previewing the video clip via customer computer 110, a customer selects to purchase the video file. Payment gateway 111 handles the payment transactions. File download manager 112 ensures that the customer has completed the payment before allowing the customer to download the processed video file. A dedicated customer file server 113 may be maintained in the network environment. Customer file server 113 stores the purchased video files for each customer. Customers may login to their dedicated customer file server 113 to download the purchased video files or set them aside for archival purposes.

After the uploading has been initiated for a video file, the cameraman can use mobile application 114 to query process control server 106 on the status of the video file. The mobile application 114 can report on the status using any one of the following terms: (1) uploading; (2) uploaded; (3) converting and (4) converted. Process control server 106 can also provide video file sales information to the cameraman via mobile application 114, by obtaining this information from database server 108.

News footage trading platform 100 allows cameramen to easily upload captured footage, showcase the captured footage to news broadcasters, and allow the news broadcasters to purchase the captured footage. Although the platform system as depicted in FIG. 1 shows multiple machines performing separate tasks, one skilled in the art will appreciate that all the tasks may be implemented on a virtual machine environment (for example, using VMware solution) such that only one or a few machines or servers are required.

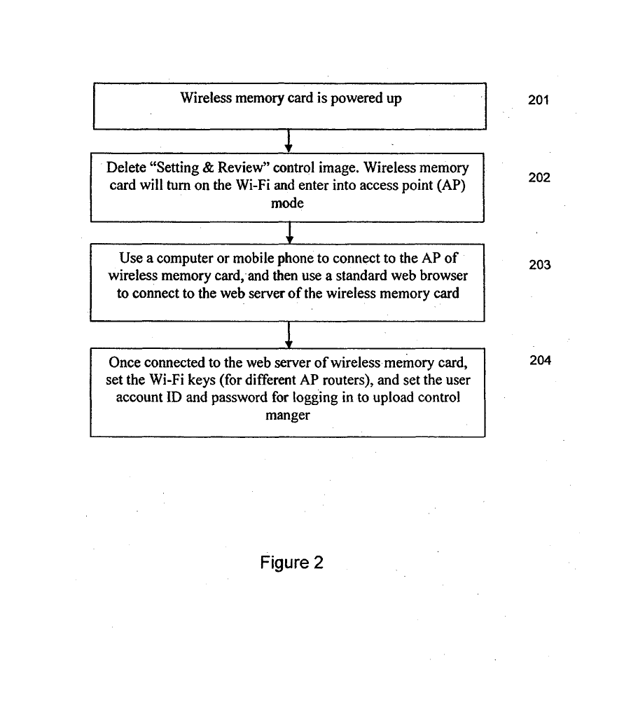

FIG. 2 shows the steps of pre-configuring wireless memory card 102 prior to use with news footage trading platform 100. In step 201, wireless memory card 102 is powered up.

In step 202, the “Setting & Review” control image is deleted. Wireless memory card 102 will turn on the Wi-Fi and enter into access point (AP) mode.

In step 203, the cameraman can use a computer or mobile device to connect to the AP of wireless memory card 102, and then use a standard web browser to connect to the web server of the wireless memory card 102.

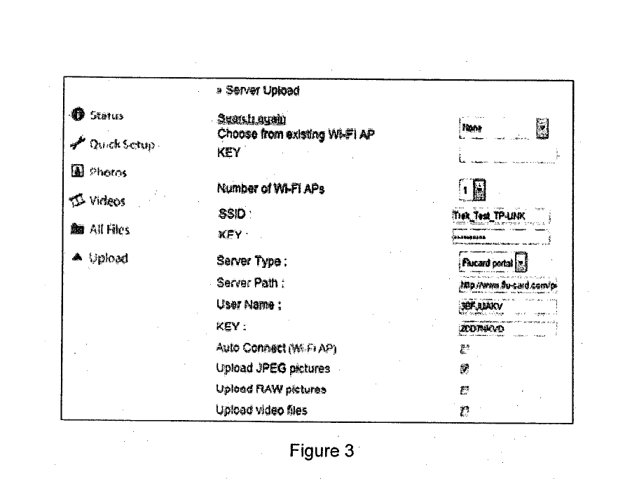

Once connected to the web server of wireless memory card 102, in step 204, the cameraman or user can set the Wi-Fi keys (for different AP routers), and set the user account ID and password for logging in to upload control manager 103 as shown in FIG. 3 (which is a screen capture of the web server interface). This information forms part of the metadata. To obtain the user account ID and password, a cameraman would have to first register with news footage trading platform 100. The registration of a cameraman with news footage trading platform 100 will be described later.

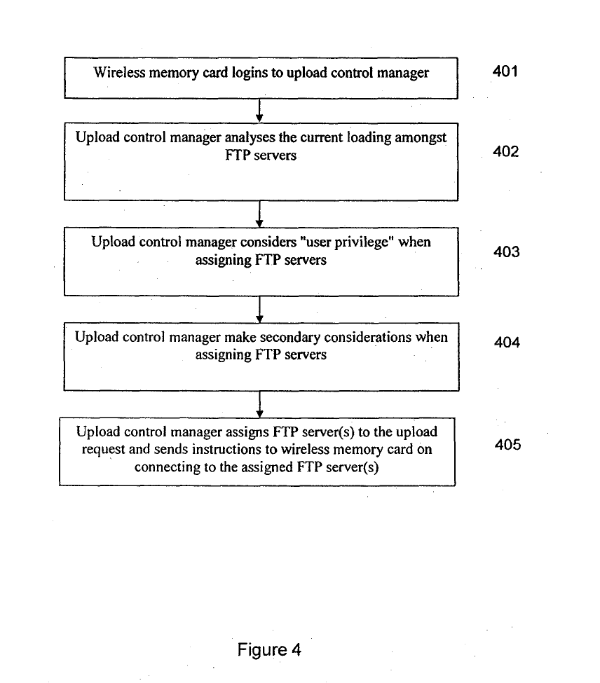

Another objective of the invention is to provide automated load balancing and automated task prioritization among FTP servers 104 such that the FTP servers 104 can efficiently handle multiple uploading operations concurrently. The uploading of data is controlled such that the uploading load is distributed evenly among selected FTP servers 104. The invention seeks to achieve this by utilizing upload control manager 103 to direct external client service requests and assign the appropriate FTP server 104 to handle each service request. FIG. 4 describes this in detail.

FIG. 4 shows the steps taken in load balancing. In step 401, wireless memory card 102 logins to upload control manager 103. In step 402, upload control manager 103 analyses the current loading amongst FTP servers 104 to assign the appropriate FTP server 104 for wireless memory card 102 to upload video files. Upload control manager 103 will look for an FTP server 104 which is not as heavily loaded as compared to the other FTP servers 104.

In step 403, upload control manager 103 considers “user privilege” when assigning FTP servers 104. For example, premium users (cameramen who pay a premium for special privileges) may have more FTP servers 104 reserved for them and may be assigned FTP servers 104 with higher server-user ratio (ratio of users to a server). Furthermore, upload control manager 103 may assign a dedicated FTP server 104 and a dedicated process control server 106 for premium users.

In step 404, upload control manager 103 make secondary considerations when assigning the appropriate FTP servers 104 for wireless memory card 102 to upload video files. Such secondary considerations non-exhaustively include user's uploading speed. For example, if user's uploading speed is slow, such as when uploading is via mobile phone tethering, upload control manager 103 will allocate an FTP server 104 which is under-utilized to compensate for the slow uploading speed.

In step 405, upload control manager 103 assigns FTP server(s) 104 to the upload request and sends instructions to wireless memory card 102 on connecting to the assigned FTP server(s) 104. There are a few ways upload control manager 103 can do this. Upload control manager 103 can send to wireless memory card 102 a specific user account/password to direct the FTP request to the assigned FTP server(s) 104. Alternatively, upload control manager 103 can also send to wireless memory card 102 the specific IP address (and network port number) of the assigned FTP server(s) 104.

One skilled in the art can appreciate that this novel process is in contrast to the one-step login-and-upload process conventionally used. The distinguishing factor in this process is that upload control manager 103 has the capability to monitor the work-load of the FTP servers 104 and can then assign the appropriate (less busy) FTP server 104 for various upload requests, hence achieving load balancing. Upload control manager 103 can also take into account secondary considerations like user uploading speed, to assign the appropriate FTP server (s) 104 to the user.

Furthermore, upload control manager 103 can distinguish between normal users and premium users and assign FTP server(s) 104 based on the “user privilege”. This is done by “pre-classing” users into differing account types, with each account type having different service priorities. For instance, premium users who pay more for their account will be entitled to a wider allocation of available computing resources (like FTP servers 104 and processor servers 107). Upload control manager 103 can also intentionally reserve a group of FTP servers 104 to service premium user requests only. This form of multi-tiered resource allocation is not supported by the typical load balancing hardware available today.

In the same vein, process control server 106 can also perform load balancing by assigning specific processor servers 107 to perform the processing.

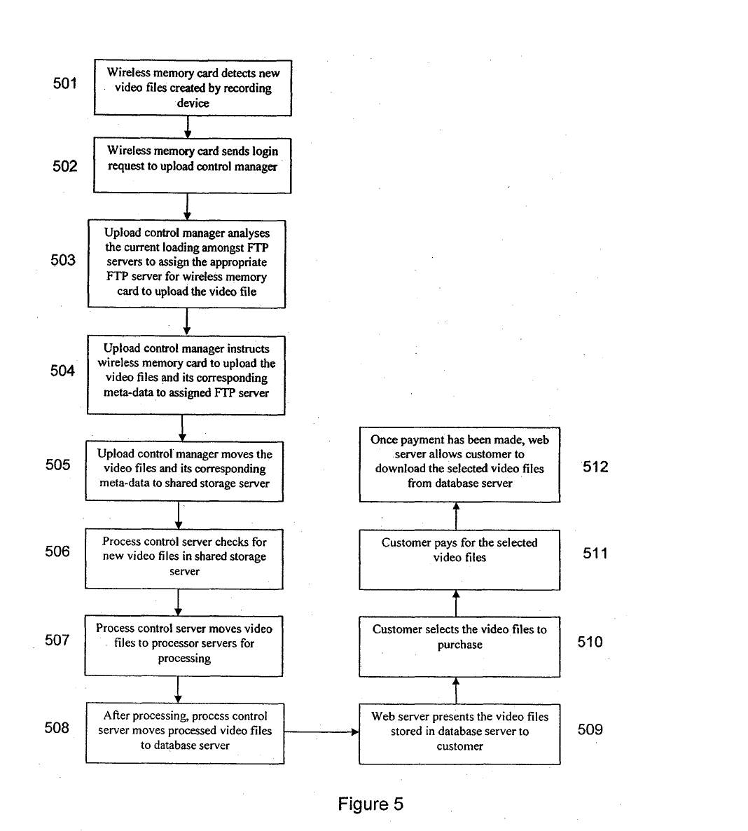

FIG. 5 is a flowchart which shows the method of uploading a video file from wireless memory card 102 onto database server 108 in accordance with a preferred embodiment of the invention.

In step 501, wireless memory card 102 detects new video files created by recording device 101.

Once wireless memory card 102 has wireless connection to Internet (for example, Wi-Fi), in step 502 wireless memory card 102 sends login request to upload control manager 103

In step 503, upload control manager 103 analyses the current loading amongst FTP servers 104 to assign the appropriate FTP server 104 for wireless memory card 102 to upload the video file. The appropriate FTP server 104 would be the one not as heavily loaded as compared to the other FTP servers 104.

In step 504, upload control manager 103 instructs wireless memory card 102 to upload the video files and its corresponding meta-data to assigned FTP server 104.

Once the uploading to assigned FTP server 104 is complete, in step 505 upload control manager 103 moves the video files and its corresponding meta-data to shared storage server 105.

In step 506, process control server 106 checks for new video files in shared storage server 105.

In step 507, process control server 106 moves video files to processor servers 107 for processing.

In step 508, after processing, process control server 106 moves processed video files to database server 108.

In step 509, web server 109 presents the video files stored in database server 108 to customer.

In step 510, customer selects the video files to purchase.

In step 511, customer pays for the selected video files.

In step 512, once payment has been made, web server 109 allows customer to download the selected video files from database server 108.

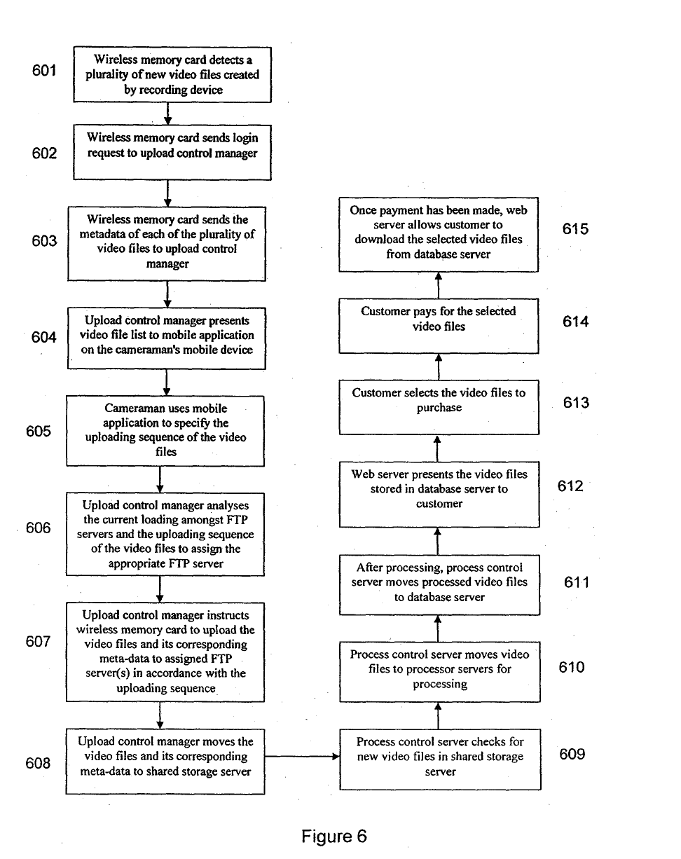

As mentioned, one of the objectives of this invention is to reduce the time-to-market of newly recorded video files. This is especially important when the video file contains breaking-news type footage. Therefore, in the event that a user has multiple video files to upload, there should be some prioritizing mechanism in place for the user to set the priority of uploading specific video files first. As most recording devices 101 do not have a specialized interface for cameramen to interact with the wireless memory card 102, mobile application 114 may be used to login into upload control manager 103 to select which video files to upload, and to set the order or sequence of the uploading of video files to FTP server (s) 104. This would allow a cameraman who has taken multiple videos to select which video file should be given the highest priority to upload, and which video files to delay uploading or to cancel uploading. FIG. 6 is similar to FIG. 5 in that it also shows the method of uploading a video file from wireless memory card 102 onto database server 108 but it has the additional step of allowing cameramen to set the order or sequence of the uploading of video files to FTP server (s) 104.

In step 601, wireless memory card 102 detects a plurality of new video files created by recording device 101.

Once wireless memory card 102 has wireless connection to Internet (for example, Wi-Fi), in step 602 wireless memory card 102 sends login request to upload control manager 103.

In step 603, wireless memory card 102 sends the metadata of each of the plurality of video files to upload control manager 103.

In step 604, upload control manager 103 presents video file list to mobile application 114 on the cameraman's mobile device.

In step 605, cameraman uses mobile application 114 to specify the uploading sequence of the video files (i.e. the order in which the video files are uploaded).

In step 606, upload control manager 103 analyses the current loading amongst FTP servers 104 and the uploading sequence of the video files to assign the appropriate FTP server 104.

In step 607, upload control manager 103 instructs wireless memory card 102 to upload the video files and its corresponding meta-data to assigned FTP server(s) 104 in accordance with the uploading sequence.

Once the uploading to assigned FTP server 104 is complete, in step 608, upload control manager 103 moves the video files and its corresponding meta-data to shared storage server 105.

In step 609, process control server 106 checks for new video files in shared storage server 105.

In step 610, process control server 106 moves video files to processor servers 107 for processing.

In step 611, after processing, process control server 106 moves processed video files to database server 108.

In step 612, web server 109 presents the video files stored in database server 108 to customer.

In step 613, customer selects the video files to purchase.

In step 614, customer pays for the selected video files.

In step 615, once payment has been made, web server 109 allows customer to download the selected video files from database server 108.

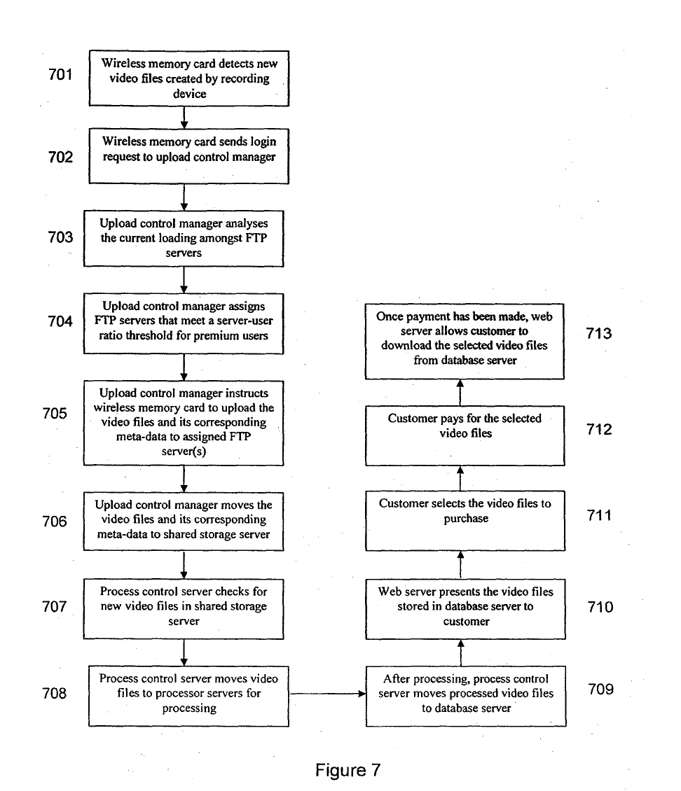

FIG. 7 is similar to FIG. 5 in that it also shows the method of uploading a video file from wireless memory card 102 onto database server 108 but it has the additional step of assigning FTP servers 104 that meets a server-user ratio threshold to premium users.

In step 701, wireless memory card 102 detects new video files created by recording device 101.

Once wireless memory card 102 has wireless connection to Internet (for example, Wi-Fi), in step 702 wireless memory card 102 sends login request to upload control manager 103.

In step 703, upload control manager 103 analyses the current loading amongst FTP servers 104.

In step 704, upload control manager 103 assigns FTP servers 104 that meet a server-user ratio threshold for premium users. This server-user ratio threshold is high i.e. small number of users assigned to one server. Alternatively, instead of upload control manager 103 sourcing for FTP servers 104 that meet a server-user threshold, upload control manager 103 can assign dedicated FTP servers 104 to the uploading operation.

In step 705, upload control manager 103 instructs wireless memory card 102 to upload the video files and its corresponding meta-data to assigned FTP server(s) 104.

Once the uploading to assigned FTP server 104 is complete, in step 706 upload control manager 103 moves the video files and its corresponding meta-data to shared storage server 105.

In step 707, process control server 106 checks for new video files in shared storage server 105.

In step 708, process control server 106 moves video files to processor servers 107 for processing.

In step 709, after processing, process control server 106 moves processed video files to database server 108.

In step 710, web server 109 presents the video files stored in database server 108 to customer.

In step 711, customer selects the video files to purchase.

In step 712, customer pays for the selected video files.

In step 713, once payment has been made, web server 109 allows customer to download the selected video files from database server 108.

It is also important to incentivise cameramen to upload news footage onto news footage trading platform 100. It is also important to incentivise cameramen to upload “news worthy” footage onto the news footage trading platform. As such, it is preferable that database server 108 or file download manager 112 has the capability of determining the cameraman whose uploaded video files have garnered the highest number of purchases. Alternatively, the cameraman who has the highest upload-to-purchase ratio could be determined. The upload-to-purchase ratio is the number of uploaded video files which have been purchased against the total number of uploaded video files by a particular cameraman. These cameramen who have performed exceptionally well will be rewarded and recognized with monetary awards or credits for storage purchase. Another possible way to identify the “top performers” would be for database server 108 or file download manager 112 to track the number of “hits” on each video clip, and reward the cameraman whose video clip was most frequently viewed.

Preferably, news footage trading platform 100 also provides an online registration portal. This portal can be hosted by any suitable server in news footage trading platform 100. This portal is for cameramen to register with the news footage trading platform 100 by providing his personal details (e.g. name, address, identification number) and bank details. During registration, each cameraman would be provided a user account ID and be prompted to provide a password. This user account ID and password is necessary for wireless memory card 102 to log into upload control manager 103 as shown in FIG. 3 and FIG. 4. The portal also allows each cameraman to list their favourite news broadcasters. An email system within the news footage trading platform 100 will send email notifications with links for basic plan sign up to these news broadcasters so that news broadcasters who have not signed up yet with news footage trading platform 100 yet can sign up. Email updates of uploaded videos to these news broadcasters will be sent automatically and periodically to pique their interest. Conceptually, this can be done be linking the emails of the news broadcasters to a new video file upload.

One skilled in the art can see that a news footage trading platform has been disclosed which allows cameraman to easily upload captured footage, showcase the captured footage to news broadcasters, and allow the news broadcasters to purchase the captured footage. The cameraman makes money when the video file is purchased by a news broadcaster. The operator of the news footage platform can generate revenue stream through an annual subscription paid by the news broadcasters or through a fixed charge through each video file purchase and download (for example, the operator takes a cut or a portion of the purchase price).

Although throughout the specifications, the invention has been described using removable wireless memory card 102 which is non-integral with recording device 101, one skilled in the art can appreciate that instead of removable wireless memory card 102, the invention can function just as well with a recording device 101 with built-in wireless capabilities. In such an embodiment, recording device 101 would have a wireless module which replicates the functionality of wireless memory card 102.

Through throughout the specifications, the invention has been described with news footage in the form of video files being uploaded, processed etc., one skilled in the art can appreciate that news footage can also refer to digital photographs and that the invention can function in the same manner using digital photographs.

In the application, unless specified otherwise, the terms “comprising”, “comprise”, and grammatical variants thereof, intended to represent “open” or “inclusive” language such that they include recited elements but also permit inclusion of additional, non-explicitly recited elements.

It will be apparent that various other modifications and adaptations of the application will be apparent to the person skilled in the art after reading the foregoing disclosure without departing from the spirit and scope of the application and it is intended that all such modifications and adaptations come within the scope of the appended claims.

1. A system for uploading, showcasing and selling news footage on the Internet, the system comprising:
a upload control manager configured to receive an upload request from a wireless module on a recording device, the upload request including an identification number;
a plurality of FTP servers, the upload control manager configured to select at least one FTP server from the plurality of FTP servers to service the upload request and receive news footage from the wireless module, the news footage recorded by the recording device;
a database server configured to receive the news footage from the plurality of FTP servers and for showcasing the news footage on the Internet to allow customers to preview and purchase the news footage; and
wherein the upload control manager selects the at least one FTP server based upon the upload control manager determining the least loaded FTP servers amongst the plurality of FTP servers and based upon user privileges tagged to the identification number.

2. The system of claim 1 wherein the user privileges tagged to the identification number include any one of: selecting a dedicated FTP server or selecting a FTP server that satisfies a server-user ratio threshold.

3. The system of claim 1 or 2 wherein the news footage is a plurality of video files and the upload control manager is configured to receive metadata of the plurality of video files from the wireless module, and send to a mobile application a video file list, the video file list providing selection on the sequence in which the plurality of video files will be uploaded to the at least one selected FTP server.

4. The system of claim 1 or 2 further comprising a process control server and a plurality of processing servers for processing the news footage.

5. The system of claim 1 or 2 wherein the wireless module is built-in to the recording device or is part of a removable wireless memory card attached to the recording device.

6. A method for uploading, showcasing and selling news footage on the internet, the method comprising the steps of:
receiving on a upload control manager, an upload request from a wireless module on a recording device, the upload request including an identification number;
selecting using the upload control manager, at least one FTP server from a plurality of FTP servers to service the upload request, the selecting based upon the upload control manager determining the least loaded FTP servers amongst the plurality of FTP servers and based upon user privileges tagged to the identification number;
receiving on the at least one selected FTP server, news footage from the wireless module, the news footage recorded by the recording device; and
transferring the news footage from the at least one selected FTP server to a database server, to showcase the news footage on the internet to allow customers to preview and purchase the news footage.

7. The method of claim 6 wherein the user privileges tagged to the identification number include any one of: selecting a dedicated FTP server or selecting a FTP server that satisfies a server-user ratio threshold.

8. The method of claim 6 or 7 wherein the news footage is a plurality of video files, the method further comprising the steps of:
receiving on the upload control manager, metadata of the plurality of video files from the wireless module; and
sending from the upload control manager, a video file list to a mobile application, the video file list providing selection on the sequence in which the plurality of video files will be uploaded to the at least one selected FTP server.

9. The method of any one of claims 6 and 7 further comprising the step of:
processing the news footage with a process control server and a plurality of processing servers.

10. The method of any one of claims 6 and 7 wherein the wireless module is built-in to the recording device or is part of a removable wireless memory card attached to the recording device.

11. The method of any one of claims 6 and 7, wherein the news footage created on the recording devices is created by a user, and the purchase price is set by the user.

12. The system of any one of claims 1 and 2, wherein the user operates the recording device and the purchase price is set by the user.
